(19) United States
(12) Patent Application Publication
(10) Pub. No.: US 2017/0312848 A1
(43) Pub. Date: Nov. 2, 2017

(54) WELDING TIP INSPECTION APPARATUS AND METHOD

(71) Applicant: Hyundai Motor Company, Seoul (KR)

(72) Inventor: Jae Woong Jang, Ulsan (KR)

(21) Appl. No.: 15/352,750

(22) Filed: Nov. 16, 2016

(30) Foreign Application Priority Data
May 2, 2016 (KR) 10-2016-0054059

(51) Int. Cl. B23K 11/30; G01N 21/25

(52) U.S. Cl. CPC B23K 11/3063; G01N 21/251

(57) ABSTRACT

A welding tip inspection apparatus and method to mom accurately inspect dressing quality and a foreign object attachment regarding a front end of a welding tip using a color sensing technique is provided. The welding tip inspection apparatus includes an inspection block on which a front end of a welding tip is mounted, a color sensor that is disposed within the inspection block, that is configured to irradiate light to the front end of the welding tip and that is configured to receive the reflected light from the front end of the welding tip. A controller is configured to analyze a wavelength of each color of the reflected light received by the color sensor.

### CROSS-REFERENCE TO RELATED APPLICATION

This application is based on and claims the benefit of priority to Korean Patent Application No. 10-2016-0054059, filed on May 2, 2016, in the Korean Intellectual Property Office, the disclosure of which is incorporated herein in its entirety by reference.

### BACKGROUND

### Field of the Invention

The present disclosure relates to a welding tip inspection apparatus and method, and more particularly, to a welding tip inspection apparatus and method capable of more accurately inspecting dressing quality and a foreign object attachment to a front end of a welding tip using a color sensing technique.

### Description of the Related Art

Generally, when welding equipment (e.g., a spot welding machine) performs welding a predetermined number of times, a front end of a welding tip may be deformed or a foreign object may be attached to the front end of the welding tip due to pressurization and heating. Accordingly, after a welding operation is performed a predetermined number of times, the front end of the welding tip may be dressed by a tip dresser to be restored to an original state.

After the front end of the welding tip is dressed by the tip dresser, a welding tip inspection apparatus inspects dressing quality of the front end of the welding tip. In the related art, a welding tip inspection apparatus inspects the front end of the welding tip based on a quantity of reflected light by a photo sensor. However, in the related art welding tip inspection apparatus, spatters are fixed to the front end of the welding tip based on a quantity of reflected light. For example, when roughness of the fixed spatters is increased, light reflectivity may be increased, causing difficulty in inspecting a contamination state caused by the fixed spatters.

The above information disclosed in this section is merely for enhancement of understanding of the background of the invention and therefore it may contain information that does not form the prior art that is already known in this country to a person of ordinary skill in the art.

### SUMMARY

The present disclosure provides a welding tip inspection apparatus and method that uses a color sensing technique to more accurately inspecting dressing quality and a foreign object-attached state of a front end of a welding tip.

According to an exemplary embodiment of the present disclosure, a welding tip inspection apparatus may include an inspection block on which a front end of a welding tip is mounted, a color sensor disposed within the inspection block configured to irradiate light to the front end of the welding tip and receive reflected light reflected from the front end of the welding tip and a controller configured to analyze a wavelength of each color of the reflected light received by the color sensor.

The inspection block may have an inspection aperture and the color sensor may be disposed within the inspection aperture. The inspection block may have a mounting surface on which the front end of the welding tip may be mounted. The mounting surface may be formed in a position facing to the inspection aperture. The inspection block may have a cover configured to open and close the inspection aperture. The cover may be adjusted to advance and retract by an operating cylinder to open and close the inspection aperture. The inspection block may include an air blower configured to circulate air to an interior of the inspection aperture.

According to another exemplary embodiment of the present disclosure, a welding tip inspection apparatus may include an inspection block disposed adjacent to a tip dresser that dresses a front end of the welding tip, a color sensor configured to irradiate light to the front end of the welding tip dressed by the tip dresser and receive reflected light reflected from the front end of the welding tip and a controller electrically connected to the color sensor and configured to analyze a wavelength of each color of the reflected light received by the color sensor. The tip dresser and the inspection block may be disposed be parallel to each other by a bracket. The bracket may have a first coupling portion coupled to the tip dresser and a second coupling portion coupled to the inspection block.

According to another exemplary embodiment of the present disclosure, a welding tip inspection method may include irradiating and reflecting light to a front end of a welding tip by a color sensor of an inspection block and subsequently receiving reflected light, analyzing, by the controller, a wavelength of each color of the reflected light received by the color sensor, and determining, by the controller, a defect by comparing the analysis value obtained with a preset reference value and determining whether the front end of the welding tip is defective.

The method may further include adjusting a welding tip dressed by the tip dresser toward the inspection block before the irradiating and reflecting the light. When the welding tip is adjusted, the welding tip dressed by the tip dresser may be moved toward an inspection aperture of the inspection block by a welding machine. Further, during the irradiating and reflecting operation, white light may be irradiated to the front end of the welding tip from a light source of a color sensor and reflected light thereof may be received by a light receiving portion of the color sensor. In some exemplary embodiments, analyzing may include analyzing by the controller, a wavelength of each color of the reflected light received by the light receiving portion of the color sensor and a color may be subsequently identified based on a ratio of the wavelength value.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary perspective view illustrating a welding tip inspection apparatus according to various exemplary embodiments of the present disclosure;

FIG. 2 is an exemplary cutaway perspective view illustrating a partially cut welding tip inspection apparatus according to various exemplary embodiments of the present disclosure;

FIG. 3 is an exemplary side view illustrating a welding tip inspection apparatus according to an exemplary embodiment of the present disclosure;

FIG. 4 is an exemplary cross-sectional view taken along line A-A of FIG. 3 according to various exemplary embodiments of the present disclosure;

FIG. 5 is an exemplary perspective view illustrating a welding tip inspection apparatus according to various exemplary embodiments of the present disclosure is installed to be adjacent to a tip dresser, and

FIG. 6 is an exemplary flow chart illustrating a welding tip inspection method according to various exemplary embodiments of the present disclosure.

### DETAILED DESCRIPTION

Hereinafter, exemplary embodiment of the present disclosure will be described in detail with reference to the accompanying drawings. For reference, dimensions of elements or thicknesses of lines illustrated in the drawings referred to describe the present disclosure may be exaggerated for the convenience of understanding. Also, the terms used henceforth have been defined in consideration of the functions of the present disclosure, and may be altered according to the intent of a user or operator, or conventional practice. Therefore, the terms should be defined on the basis of the entire content of this specification. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

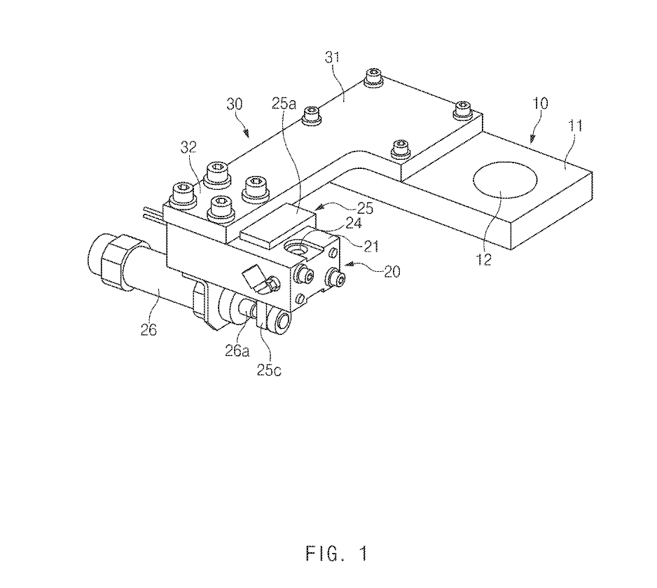

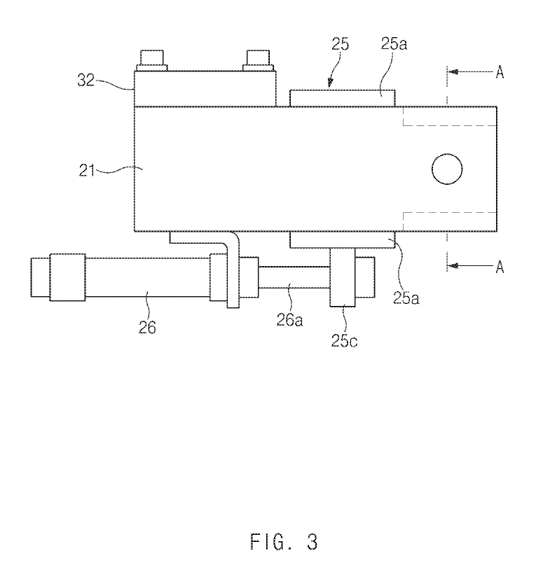

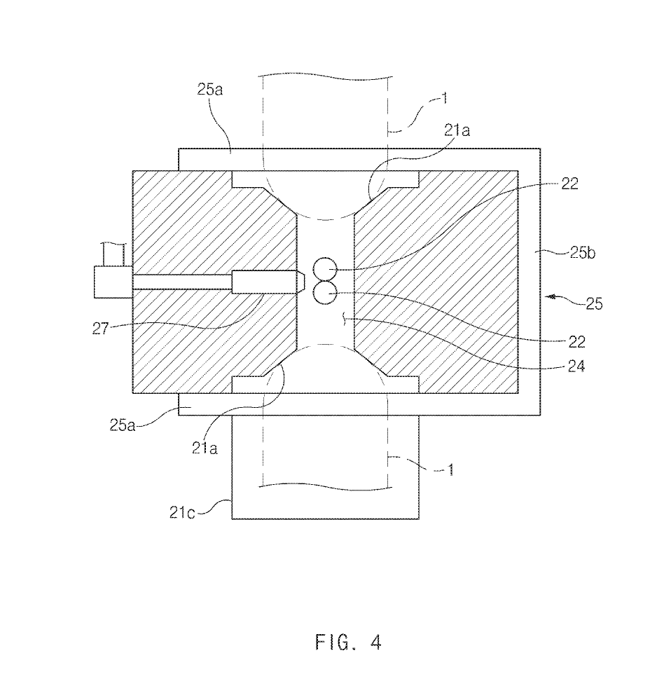

Referring to FIGS. 1 to 4, a welding tip inspection apparatus 20 according to various exemplary embodiments of the present disclosure may include a front end of a welding tip 1 mounted to an inspection block 21, a color sensor 22 disposed within the inspection block 21 and a controller 23 electrically connected to the color sensor 22. The inspection block 21 may have a mounting surface 21a on which the front end of the welding tip 1 is mounted. In a resistance welder (e.g., a spot welding machine), the welding tip 1 may be formed as a pair as illustrated in FIG. 4. A pair of mounting surfaces 21a may be symmetrically formed on an upper surface and a lower surface of the inspection block 21. In particular, the mounting surface 21a may be tapered to orient the front end of the welding tip 1 in a direction toward an axial line of an inspection aperture 24.

The inspection block 21 may include an inspection aperture 24 and the color sensor 22 may be disposed within the inspection aperture 24. In particular, a light source and a light receiving portion of the color sensor 22 may be disposed to be exposed within the inspection aperture 24. In particular, when the mounting surface 21a is formed in a position facing the inspection aperture 24, the front end of the welding tip 1 may be more stably maintained and may be spaced apart at a predetermined distance from the color sensor 22 within the inspection aperture 24. The color sensor 22 may have a light source (not shown) configured to emit light (e.g., white light) and a light receiving portion (not shown) configured to receive the reflected light. The light source of the color sensor 22 may be configured to emit white light with high luminance and the light receiving portion of the color sensor 22 may be configured to receive reflected light generated as white light emitted from the light source may be reflected from the front end of the welding tip 1. The light receiving portion may include a light detector and color filters to detect a wavelength of each of red, green, and blue colors, or the like.

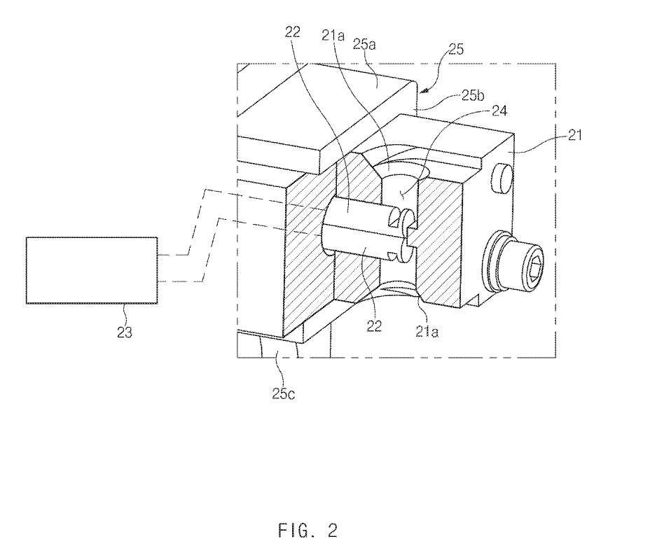

As illustrated in FIGS. 2 and 4, a pair of color sensors 22 may be disposed symmetrically in a vertical arrangement to simultaneously inspect a pair of welding tips 1. The controller 23 may be electrically connected to the color sensor 22 and may be configured to analyze a wavelength of each color of reflected light received by the light receiving portion of the color sensor 22 and identify each color based on a ratio of the wavelength value. The controller 23 may be configured to compare the analysis value with a preset reference value to determine whether the analysis value is within a normal or defective range. Through the determination process, the dressing quality of the front end of the welding tip 1, whether a foreign object is attached thereto and the like, may be more accurately inspected. Further, the inspection block 21 may include a cover 25 configured to open and close the inspection aperture 24. The cover 25 may have a pair of cover components 25a simultaneously opening and closing upper opening and lower opening of the inspection aperture 24. The pair of cover components 25a may be integrally formed through a connection portion 25b. Accordingly, the cover 25 may be positioned to slide on an exterior circumferential surface of the inspection block 21 and may be configured to selectively open and close the inspection aperture 24.

Further, when the welding tip 1 is not inspected, the cover 25 may close the inspection aperture 24 to prevent an external foreign object from being introduced to the inspection aperture 24 to protect the color sensor 22. When the welding tip 1 is inspected, the cover 25 may be positioned to open the inspection aperture 24. The cover 25 may be configured to be adjusted by an operating cylinder 26 to retract and advance in a horizontal direction on an exterior circumferential surface of the inspection block 21. A mounting component 25c may be disposed on one side of the cover 25. A front end of a rod 26a of the operating cylinder 26 may be coupled to the mounting component 25c of the cover 25. Accordingly, as the rod 26a of the operating cylinder 26 advances and retracts in a horizontal direction (e.g., forwards and backwards), the cover 25 may also be adjusted to advance and retract in a horizontal direction. The inspection block 21 may include an air blower 27 configured to circulate air to an interior of the inspection aperture 24. When a nozzle of the air blower 27 is installed to face the color sensor 22 within the inspection aperture 24, an introduction of an external foreign object may be prevented and may facilitate cleaning of the color sensor 22.

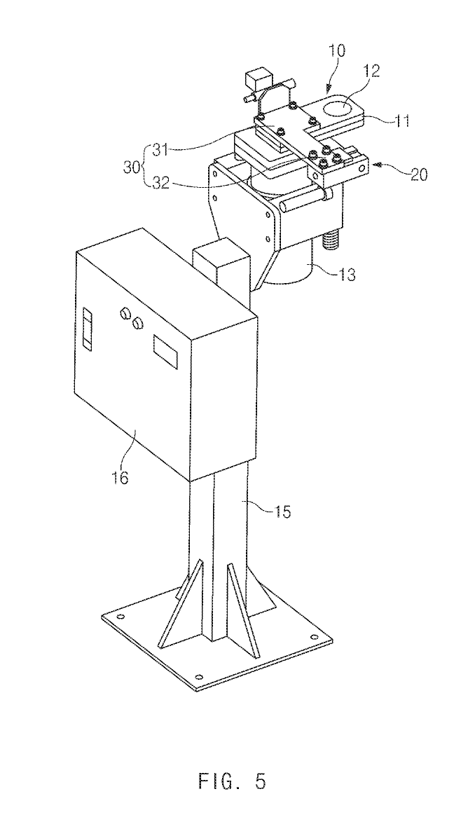

As illustrated in FIGS. 1 and 5, the welding tip inspection apparatus 20 according to an exemplary embodiment of the present disclosure may be disposed adjacent to the tip dresser 10. Accordingly, the front end of the welding tip 1 dressed by the tip dresser 10 may be rapidly and more stably inspected. The tip dresser 10 may include a body 11 supported by a support frame 15, a cutter tool 12 disposed within in the body 11 to dress the front end of the welding tip 1 and a driving motor 13 configured to actuate the cutter tool 12. A control panel 16 may be disposed on one side of the support frame 15, and the controller 23 may be integrally connected in the control panel 16.

The tip dresser 10 and the inspection block 21 of the welding tip inspection apparatus 20 may be disposed to be parallel to each other by a bracket 30. In particular, since the tip dresser 10 and the inspection block 21 may be disposed to be adjacent to each other by the bracket 30, the front end of the welding tip 1 dressed by the tip dresser 10 may be rapidly adjusted toward the inspection block 21. Accordingly, inspection accuracy of the dressed front end of the welding tip may be further enhanced. The bracket 30 may have a first coupling portion 31 coupled to the tip dresser 10 a plurality of fasteners, or the like. A second coupling portion 32 may be coupled to the inspection block 21 by a plurality of fasteners, or the like.

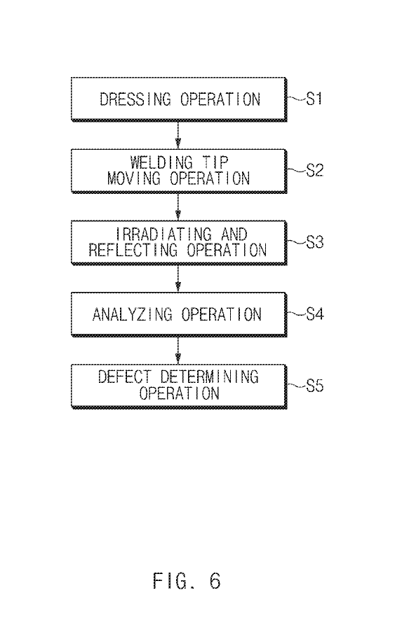

FIG. 6 is an exemplary flow chart illustrating a welding tip inspection method according to various exemplary embodiments of the present disclosure. Referring to FIG. 6, the welding tip inspection method according to various exemplary embodiments of the present disclosure may include a dressing operation S1, a welding tip adjustment operation S2, an irradiating and reflecting operation S3, an analyzing operation S4, and a defect determining operation S5.

In the dressing operation S1, a front end of the welding tip 1 may be dressed by the cutter tool 12 of the tip dresser 10. The welding tip adjustment operation S2, may include the welding tip 1 dressed by the tip dresser 10 adjusted toward the inspection aperture 24 of the inspection block 21 by a moving component (not shown) of a welding machine. In particular, the front end of the welding tip 1 may be mounted on the mounting surface 21a of the inspection block 21 adjacent to the inspection aperture 24. In the irradiating and reflecting operation S3, light (e.g., white light) may be irradiated to the front end of the welding tip 1 from the light source of the color sensor 22. The reflected light may be subsequently received by the light receiving portion of the color sensor 22.

The analyzing operation S4 may include analysis by the controller 23, of a wavelength of each color of reflected light received by the light receiving portion of the color sensor 22. A color may subsequently be identified based on a ratio of the wavelength value. In the defect determining operation S5, the analysis value obtained by the controller 23 may be compared with a preset reference value to determine whether the front end of the welding tip 1 is defective. Through the determination operation dressing quality of the front end of the welding tip 1, whether a foreign object is attached thereto, and the like may be more accurately inspected.

As described above, according to the exemplary embodiments of the present disclosure, when reflected light from the front end of the welding tip is analyzed by wavelengths of red, green and blue (RGB) colors using the color sensor cleanness of the front end of the welding tip may be more accurately inspected and the dressing quality of the front end of the welding tip may be more accurately inspected. Additionally, a color (e.g., gray color to black color) of a foreign object such as a spatter or the like may be more accurately detected based on a unique color (e.g., yellow color) of the front end of the welding tip by the color sensor. Further, the attachment of a foreign object to the front end of the welding tip may be more accurately inspected.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A welding tip inspection apparatus, comprising:
an inspection block having a welding tip is mounted on which a front end of a welding tip is mounted;
a color sensor disposed within the inspection block, configured to irradiate light to the front end of the welding tip, and receive reflected light from the front end of the welding tip; and
a controller configured to analyze a wavelength of each color of the reflected light received by the color sensor.

2. The welding tip inspection apparatus according to claim 1, wherein the inspection block has an inspection aperture, and the color sensor is disposed within the inspection aperture.

3. The welding tip inspection apparatus according to claim 2, wherein the inspection block has a mounting surface on which the front end of the welding tip is mounted, and the mounting surface is formed in a position facing the inspection aperture.

4. The welding tip inspection apparatus according to claim 2, wherein the inspection block includes a cover configured to open and close the inspection aperture.

5. The welding tip inspection apparatus according to claim 4, wherein the cover is configured to advance and retract by an operating cylinder to open and close the inspection aperture.

6. The welding tip inspection apparatus according to claim 2, wherein the inspection block includes an air blower configured to circulate air to an interior of the inspection aperture.

7. A welding tip inspection apparatus, comprising:
an inspection block disposed adjacent to a tip dresser that dresses a front end of a welding tip;
a color sensor configured to irradiate light to the front end of the welding tip dressed by the tip dresser and receive reflected light reflected from the front end of the welding tip; and
a controller electrically connected to the color sensor and configured to analyze a wavelength of each color of the reflected light received by the color sensor.

8. The welding tip inspection apparatus according to claim 7, wherein the tip dresser and the inspection block are disposed parallel to each other positioned by a bracket.

9. The welding tip inspection apparatus according to claim 8, wherein the bracket has a first coupling portion coupled to the tip dresser and a second coupling portion coupled to the inspection block.

10. The welding tip inspection apparatus according to claim 7, the tip dresser further comprising:
a body supported by a support frame;
a cutter tool disposed within in the body to dress the front end of the welding tip; and
a driving motor configured to actuate the cutter tool.

11. A welding tip inspection method, comprising:
irradiating and reflecting, by a color sensor, light to a front end of a welding tip of an inspection block;
receiving, by the color sensor, the reflected light;
analyzing, by a controller, a wavelength of each color of the reflected light received by the color sensor; and
determining, by the controller, a defect by comparing the analysis value obtained with a preset reference value and determining whether the front end of the welding tip is defective.

12. The welding tip inspection method according to claim 11, further comprising:
adjusting, by the controller, the welding tip dressed by a tip dresser toward the inspection block before the irradiating and reflecting the light.

13. The welding tip inspection method according to claim 12, wherein, during the adjustment of the welding tip, the welding tip dressed by the tip dresser is adjusted toward an inspection aperture of the inspection block by a welding machine.

14. The welding tip inspection method according to claim 11, wherein, in the irradiating and reflecting after white light is irradiated to the front end of the welding tip from a light source of the color sensor, reflected light thereof is received by a light receiving portion of the color sensor.

15. The welding tip inspection method according to claim 11, wherein, in the analyzing, a wavelength of each color of the reflected light received by the light receiving portion of the color sensor analyzed by the controller and a color is subsequently identified based on a ratio of the wavelength value.
